(19) United States
(12) Patent Application Publication
(10) Pub. No.: US 2024/0164412 A1
(43) Pub. Date: May 23, 2024

(54) COMPOSITIONS COMPRISING PLANT PROTEINS ITS METHOD OF PRODUCTION AND THE METHODS OF USE

(71) Applicant: Premier Nutrition Company, LLC, Emeryville, CA (US)

(72) Inventors: Serena Gereffi, Emeryville, CA (US); Luciana Silva, Emeryville, CA (US); Richard Andrew, Emeryville, CA (US); Venkata Pamu, Emveryville, CA (US)

(21) Appl. No.: 18/345,667

(22) Filed: Jun. 30, 2023

Related U.S. Application Data
(60) Provisional application No. 63/357,338, filed on Jun. 30, 2022.

(51) Int. Cl. A23L 2/66; A23J 3/14; A23L 29/238; A23L 29/25; A23L 29/269

(52) U.S. Cl. CPC A23L 2/66; A23J 3/14; A23L 29/238; A23L 29/25; A23L 29/27

(57) ABSTRACT

The present disclosure relates to plant-based protein compositions that when used in a beverage, create a beverage product with a superior mouthfeel.

### CROSS-REFERENCE TO RELATED APPLICATIONS

This application claims the benefit of the U.S. Provisional Application Ser. No. 63/357,338, entitled “Compositions Comprising Plant Proteins,” filed Jun. 30, 2022, the contents of which are incorporated by reference herein, for all purposes, in its entirety.

### FIELD OF THE DISCLOSURE

The present disclosure relates to plant-based protein compositions and beverages and methods of making thereof.

### BACKGROUND

Plant-based protein compositions used to make protein beverages, such as shakes on the market today suffer many drawbacks compared to dairy-based protein shakes. Not only do plant-based protein shakes often have an inferior amino acid profile with PDCAAS scores below 0.9, but they also have poor mouthfeel profiles. Most plant-based protein shakes have inferior texture characteristics that can feel gritty, chalky, sandy or that do not coat and clear the mouth well. All of these factors lead to a suboptimal consumer experience, especially for those who cannot use dairy-based protein products due to health, moral, or religious reasons.

What is needed is an improved plant-based protein composition used to create a beverage composition and the resultant beverage composition that is desired by consumers with a superior amino acid profile and better mouthfeel.

### SUMMARY OF THE DISCLOSURE

Disclosed herein is a plant-based protein composition that, when mixed with a liquid to form a beverage, imparts superior mouthfeel and texture compared to other plant-based protein beverages. The protein composition includes a protein blend and a gum blend. Additionally, the protein composition can include a lecithin. The protein blend includes a first plant protein ingredient and a second plant protein ingredient. The protein composition may have a PDCAAS of at least 0.9. In some examples, the PDCAAS score is 1.0. In some embodiments, protein composition may be a powder, wherein about 90% of the particles have a diameter of less than about 200 μm. In one example, about 90% of the particles have a diameter of less than about 150 μm. In one example, about 90% of the particles have a diameter of less than about 100 μm.

In some embodiments, the protein blend is composed of a first plant protein ingredient that includes at least one protein selected from the group consisting of pea protein, rice protein, soy protein, and combinations thereof. In one example, the first plant protein ingredient is a combination of pea protein and rice protein, wherein the pea protein has a concentration of about 50% to about 70% in the protein blend, and the rice protein has a concentration of about 10% to about 30% in the protein blend.

In some embodiments, the protein blend includes a second plant protein ingredient with at least one protein selected from the group consisting of chickpea protein, watermelon seed protein, pumpkin seed protein, chia seed protein, pea protein, rice protein, soy protein and combinations thereof. In some examples, the second protein ingredient is a combination and includes watermelon seed protein, pumpkin seed protein, and chickpea protein, wherein the watermelon seed protein has a concentration of about 1 wt % to about 7.5 wt % in the protein blend, the chickpea protein has a concentration of about 0.5 wt % to about 3.5 wt % in the protein blend, and the pumpkin seed protein has a concentration of up to 1 wt % in the protein blend. In one example, the watermelon seed protein has a concentration of about 2.5 wt % in the protein blend.

In some embodiments, the third protein blend includes a third or more additional plant protein ingredients. The additional plant protein ingredients include protein selected from the group consisting of pea protein, rice protein, soy protein, chickpea protein, watermelon seed protein, pumpkin seed protein, chia seed protein, and combinations thereof.

The protein composition includes the protein blend and a gum blend. In some embodiments, the gum blend includes gum Arabic, xanthan gum, guar gum, and combinations thereof. In some examples, the concentration of the gum blend in the protein composition is about 0.25 wt % to about 4 wt %. In one example, the gum blend includes gum Arabic, xanthan gum, and guar gum, and has a concentration of about 2 wt % in the protein composition.

In some embodiments the protein composition includes lecithin. The lecithin is selected from the group consisting of sunflower lecithin, soy lecithin, and combinations thereof. In some examples, the lecithin is sunflower lecithin, wherein the sunflower lecithin has a concentration in the protein composition of about 0.5 wt % to about 3.5 wt %. In one example, the sunflower lecithin has a concentration of about 1.3 wt % in the protein composition.

In some embodiments, the protein composition or the protein blend also includes sweeteners, flavors, a creamer, and/or salt. In some aspects, the sweeteners may have a concentration of about 0.25 wt % to about 1 wt % in the protein composition, the flavors may have a concentration of about 2 wt % to about 12 wt % in the protein composition, and the salt may have a concentration of about 0.5 wt % to about 1 wt % in the protein composition.

Further disclosed herein is a protein blend composition comprising a first plant ingredient and a second plant protein ingredient. The protein blend composition has a PDCAAS score of at least about 0.9. In some embodiments, the protein blend composition has a PDCAAS score of about 1. In some embodiments, the protein blend composition is a powder wherein about 90% of the particles have a diameter of about 200 μm or less. In some examples, about 90% of the particles have a diameter of about 150 μm or less. In some examples, about 90% of the particles have a diameter of about 100 μm or less.

In some embodiments, the first plant protein ingredient is selected from the group consisting of pea protein, rice protein, soy protein and compositions thereof. In some aspects, the first plant protein is a combination of rice protein and pea protein. In some examples, the rice protein has a concentration of about 10 wt % to about 30 wt % in the protein blend composition. In some additional examples, the pea protein has a concentration of about 50 wt % to about 70 wt % in the protein blend composition.

In some additional embodiments, the second plant protein of the protein blend composition includes a protein selected from the group consisting of chickpea protein, watermelon seed protein, pumpkin seed protein, chia seed protein, pea protein, rice protein, soy protein, and combinations thereof. In some embodiments, the second protein ingredient is a combination that includes watermelon seed protein and pumpkin seed protein. In one example, the watermelon seed protein has a concentration of about 1 wt % to about 7.5 wt % in the protein blend composition. In another example, the pumpkin seed protein has a concentration of up to about 1 wt % in the protein blend composition. In yet another example, the chickpea protein has a concentration of up to about 1 wt % in the protein blend composition.

Further disclosed herein is a protein beverage composition. The protein beverage composition includes a protein composition and water, wherein the protein composition includes a protein blend comprising a first plant protein ingredient and a second plant protein ingredient and a gum blend. In some additional embodiments the protein composition includes a lecithin. In some embodiments, the protein beverage composition further includes flavors, sweeteners, a creamer, salt, and combinations thereof. The protein beverage composition may have a PDCAAS score of at least about 0.9. In some embodiments, the protein beverage composition has a PDCAAS score of 1. In some additional embodiments, about 90% of the particles of the protein beverage composition may have a diameter of about 200 μm or less. In some aspects, about 90% of the particles of the protein beverage composition may have a diameter of about 150 μm or less. In some additional embodiments, about 90% of the particles of the protein beverage composition may have a diameter of about 110 μm or less. In some aspects, about 90% of the particles of the protein beverage composition may have a diameter of about 100 μm or less.

Further disclosed herein is a method of making a protein composition. The method includes adding a first half of a first plant protein ingredient to a vessel, adding a second plant protein ingredient to the vessel, mixing the contents of the vessel, adding a second half of the first plant protein ingredient to the vessel, and mixing the contents of the vessel. In some embodiments, the method further includes adding a gum blend to the vessel after the step of adding a second plant protein ingredient to the vessel. In some additional embodiments, the method further includes adding a lecithin to the vessel after the step of adding a second plant protein ingredient to the vessel. In still other embodiments, the method further includes adding additional ingredients to the vessel after the step of adding a second protein ingredient to the vessel, wherein the additional ingredients are selected from the group consisting of flavors, sweeteners, a creamer, salt, and combinations thereof. In still other embodiments, the method further includes adding water after the final step of mixing the contents of the vessel.

### BRIEF DESCRIPTION OF THE DRAWINGS

FIG. 1 shows a comparison chart of the D₁₀, D₅₀, and D₉₀ particle size distribution values for the protein composition of the present disclosure and two market competitors, Competitor 1 and Competitor 2, at dilution levels of 8 oz., 10 oz., and 12 oz. The y-axis shows the particle size in μm.

FIG. 2 shows a comparison chart of the D₅₀ particle size distribution values for the protein composition of the present disclosure, Competitor 1, and Competitor 2, at dilution levels of 8 oz., 10 oz., and 12 oz. The y-axis shows the particle size in μm.

FIG. 3 shows a comparison chart of the particle size distribution for the disclosed protein composition. The x-axis shows the particle size in μm and the y-axis shows the differential volume in %.

FIG. 4 shows a comparison chart of the particle size distribution for an Competitor 1 protein composition. The x-axis shows the particle size in μm and the y-axis shows the differential volume in %.

FIG. 5 shows a comparison chart of the particle size distribution for a Competitor 2 protein composition. The x-axis shows the particle size in μm and the y-axis shows the differential volume in %.

FIG. 6 shows a comparison chart of the D₁₀, D₅₀, and D₉₀ particle size values in powder form for the protein composition of the present disclosure, Competitor 1, and Competitor 2. The y-axis shows the particle size in μm.

FIG. 7 shows a comparison chart of the shear viscosities of the disclosed protein composition, Competitor 1, and Competitor 2, at shear rates of 0.5 s⁻¹, 13 s⁻¹, and 100⁻¹ and at dilution levels of 8 oz., 10 oz., and 12 oz. The y-axis shows the shear viscosity in mPa-s.

FIG. 8 shows a comparison chart of the storage modulus as a function of strain and dilution for the protein composition of the present disclosure, Competitor 1, and Competitor 2 at dilution levels of 8 oz., 10 oz., and 12 oz., measured at 2.51 rad/s and 39.8 rad/s. The y-axis shows the storage modulus (G′) in mPa.

FIG. 9 shows a comparison chart of the storage modulus plateau (mPa) and the critical strain (%) for the protein composition of the present disclosure, Competitor 1, and Competitor 2, at dilution levels of 8 oz., 10 oz., and 12 oz.

FIG. 10 shows a comparison chart of the D₁₀, D₅₀, and D₉₀ particle size values in powder form for the protein composition and ingredients of the present disclosure, Competitor 1, Competitor 2 and Competitor 3. The y-axis shows the particle size in μm.

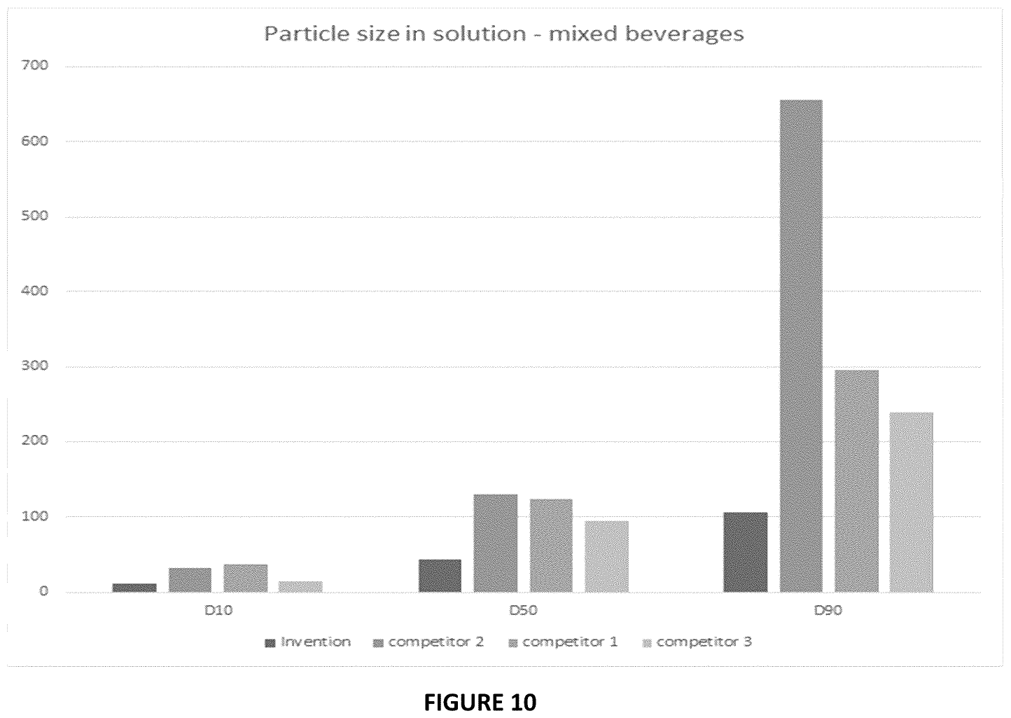

### DETAILED DESCRIPTION

It is to be understood that this disclosure is not limited to the particular methods, compositions, or materials specified herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL” The endpoint may also be based on the variability allowed by an appropriate regulatory body, such as the FDA, USP, etc.

As used herein, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

Described herein are plant-based protein compositions that, when mixed with water, provide superior mouthfeel and texture while also having a high PDCAAS score. Without being limited to any particular theory, the superior mouthfeel is imparted from the selection of proteins and additives that give rise to unique rheological properties when the protein composition is used in a beverage. The protein composition may be a powder or a granule. The protein composition may also be included in a beverage. In one example, the protein composition is provided as a powder and is then dissolved in a liquid, such as water.

### I. Composition

A protein composition of the present disclosure includes a unique protein blend that includes a first plant protein ingredient, a second plant protein ingredient and a gum blend. In some embodiments the protein composition includes a lecithin. In some embodiments, the protein composition may further include flavoring agents, sweeteners, salt, and/or a creamer or creamer blend.

The protein composition of the present disclosure has a high PDCAAS score. In some embodiments, the PDCAAS score of the protein composition may be at least about 0.9. In some aspects, the PDCAAS score of the protein composition of the present disclosure may be about 0.9 to about 0.91, about 0.91 to about 0.92, about 0.92 to about 0.93, about 0.93 to about 0.94, about 0.94 to about 0.95, about 0.95 to about 0.96, about 0.96 to about 0.97, about 0.97 to about 0.98, about 0.98 to about 0.99, about 0.99 to about 0.999, or about 0.999 to about 1. In some aspects, the PDCAAS score of the protein composition may be about 0.9, 0.91, 0.92, 0.93, 0.94, 0.95, 0.96, 0.97, 0.98, 0.99, 0.999, or about 1. In one example, the PDCAAS score of the protein composition is 1.

The protein blend and/or the protein composition may be in the form of a granule or powder. The particle size of the protein blend and/or protein composition, including the average particle size of the composition and the particle size distribution of the composition, is one component to improving variables including mouthfeel, texture, grittiness, and creaminess. Without being bound to any particular theory, a smaller average particle size and/or a more Gaussian or normal particle size distribution may lead to improved mouthfeel of the protein composition. The particle size distribution is represented herein by a Dₓ value, wherein x is the percent of the smallest particles in the protein composition, and D is the maximum diameter of those particles. As an example, a D₉₀ of 200 μm means that the smallest 90% of particles in the protein composition has a diameter of less than 200 μm.

In some embodiments, the protein blend and/or protein composition may have a D₉₀ of about 200 μm to about 80 μm. In some embodiments the protein blend and/or protein composition is from 150 μm to about 80 μm. In some embodiments the protein blend and/or protein composition is from 110 μm to about 80 μm. In some embodiments, the protein blend and/or protein composition may have a D₉₀ of less than about 200 μm, 190 μm, 180 μm, 170 μm, 160 μm, 150 μm, 140 μm, 130 μm, 120 μm 110 μm. In some embodiments the protein blend and/or protein compositions may have a D₉₀ from about 150 μm to about 105 μm, about 105 μm to about 100 μm, about 100 μm to about 95 μm, about 95 μm to about 90 μm, about 90 μm to about 85 μm, or about 85 μm to about 80 μm. In some additional aspects, the protein blend and/or protein compositions may have a D₉₀ of about 105 μm to about 85 μm or about 100 μm to about 90 μm. In yet additional aspects, the protein blend and/or protein compositions may have a D₉₀ of about 110 μm, 109 μm, 108 μm, 107 μm, 106 μm, 105 μm, 104 μm, 103 μm, 102 μm, 101 μm, 100 μm, 99 μm, 98 μm, 97 μm, 96 μm, 95 μm, 94 μm, 93 μm, 92 μm, 91 μm, 90 μm, 89 μm, 88 μm, 87 μm, 86 μm, 85 μm, 84 μm, 83 μm, 82 μm, 81 μm, or about 80 μm. In one example, the protein blend and/or protein compositions has a D₉₀ of about 90 μm.

A. First Plant Protein Ingredient

The protein composition of the present disclosure includes a protein blend that includes a first plant protein ingredient. The first plant protein ingredient provides the bulk of the protein in the composition. The first plant protein ingredient of the protein composition may include pea protein, rice protein, soy protein, and other plant proteins known to those having skill in the art, and any combinations thereof. In some embodiments, the first plant protein ingredient may include a protein isolate, a protein concentrate, and combinations thereof. In one example, the first plant protein ingredient is a combination of pea protein and rice protein. The first protein ingredient may have a concentration of about 50 wt % to about 80 wt % in the protein composition.

In one embodiment, the first plant protein ingredient includes pea protein. In some aspects the pea protein may have a concentration in the protein composition of about 50 wt % to about 70 wt %. In some additional aspects the pea protein may have a concentration in the protein composition of about 50 wt % to about 55 wt %, about 55 wt % to about 60 wt %, about 60 wt % to about 65 wt %, or about 65 wt % to about 70 wt %. In yet additional aspects, the pea protein may have a concentration in the protein composition of about 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, or about 70 wt %. In one example, the pea protein has a concentration in the protein composition of about 60 wt %, in which the pea protein is a pea protein isolate.

In some additional embodiments, the pea protein may be a powder. In some aspects, the pea protein may have a D₉₀ of about 200 μm to about 65 μm. In some aspects, the pea protein may have a D₉₀ of about 105 μm to about 65 μm. In some additional aspects, the pea protein may have a D₉₀ of about 105 μm to about 100 μm, about 100 μm to about 95 μm, about 95 μm to about 90 μm, about 90 μm to about 85 μm, about 85 μm to about 80 μm, about 80 μm to about 75 μm, about 75 μm to about 70 μm, or about 70 μm to about 65 μm. In yet additional aspects, the pea protein has a particle size of about 105 μm, 104 μm, 103 μm, 102 μm, 101 μm, 100 μm, 99 μm, 98 μm, 97 μm, 96 μm, 95 μm, 94 μm, 93 μm, 92 μm, 91 μm, 90 μm, 89 μm, 88 μm, 87 μm, 86 μm, 85 μm, 84 μm, 83 μm, 82 μm, 81 μm, 80 μm, 79 μm, 78 μm, 77 μm, 76 μm, 75 μm, 74 μm, 73 μm, 72 μm, 71 μm, 70 μm, 69 μm, 68 μm, 67 μm, 66 μm, or about 65 μm. In one example, the pea protein has a D₉₀ of about 86 μm, a D₇₅ of about 60 μm, a D₅₀ of about 41 μm, a D₂₅ of about 25 μm, and a D₁₀ of about 16 μm.

In another embodiment, the first plant protein ingredient includes rice protein. In some aspects the rice protein may have a concentration in the protein composition of about 10 wt % to about 30 wt %. In some additional aspects the rice protein may have a concentration in the protein composition of about 10 wt % to about 15 wt %, about 15 wt % to about 20 wt %, about 20 wt % to about 25 wt %, or about 25 wt % to about 30 wt %. In yet additional aspects, the rice protein may have a concentration in the protein composition of about 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, or about 30 wt %. In one example, the rice protein has a concentration in the protein composition of about 25 wt %. In some additional embodiments, the rice protein may be a powder. In one example, the rice protein has a D₉₀ of about 100 μm or less. In another example, the rice protein has a D₉₅ of about 100 μm or less.

B. Second Plant Protein Ingredient

The protein composition of the present disclosure includes a protein blend that includes a second plant protein ingredient. The second plant protein ingredient increases the PDCAAS score of the protein composition and may contribute to the superior mouthfeel and rheological properties of the protein composition and or the protein blend composition when used in a beverage. In some embodiments, the second plant protein may be a combination of protein that include chickpea protein, watermelon seed protein, pumpkin seed protein, chia seed protein, pea protein, rice protein, soy protein and other plant proteins known to those having skill in the art, and any combinations thereof. In some embodiments, the second plant protein ingredient may include a protein isolate, a protein concentrate, and combinations thereof. In one example, the second plant protein ingredient is a combination of watermelon seed protein, chickpea protein, and pumpkin seed protein.

In one embodiment, the second plant protein ingredient includes watermelon seed protein. In some aspects, the watermelon seed protein may have a concentration in the protein composition of about 1 wt % to about 7.5 wt %. In some additional aspects, the watermelon seed protein may have a concentration of about 1 wt % to about 1.5 wt %, about 1.5 wt % to about 2 wt %, about 2 wt % to about 2.5 wt %, about 2.5 wt % to about 3 wt %, about 3 wt % to about 3.5 wt %, about 3.5 wt % to about 4 wt %, about 4 wt % to about 4.5 wt %, about 4.5 wt % to about 5 wt %, about 5 wt % to about 5.5 wt %, about 5.5 wt % to about 6 wt %, about 6 wt % to about 6.5 wt %, about 6.5 wt % to about 7 wt %, or about 7 wt % to about 7.5 wt %. In still other aspects, the watermelon seed protein may have a concentration in the protein concentration of about 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, or about 7.5 wt %. In one example, the watermelon seed protein has a concentration in the protein composition of about 2.5 wt %.

In another embodiment, the second plant protein includes chickpea protein. In some aspects, the chickpea protein may have a concentration in the protein composition of about 0 wt % to about 2 wt %. In some additional aspects, the chickpea protein may have a concentration in the protein composition of about 0 wt % to about 0.5 wt %, about 0.5 wt % to about 1 wt %, about 1 wt % to about 1.5 wt %, or about 1.5 wt % to about 2 wt %. In yet additional aspects, the chickpea protein may have a concentration in the protein composition of about 0 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, or about 2 wt %. In one example, the chickpea protein has a concentration in the protein composition of about 1 wt %.

In some additional embodiments, the chickpea protein may have a particle size of about 8 μm to about 11 μm. In some aspects, the chickpea protein may have a particle size of about 8 μm to about 9 μm, about 9 μm to about 10 μm, or about 10 μm to about 11 μm. In some additional aspects, the chickpea protein may have a particle size of about 8 μm, 9 μm, 10 μm, or about 11 μm.

In yet another embodiment, the second plant protein includes pumpkin seed protein. In some aspects, the pumpkin seed protein may have a concentration in the protein composition of about 0.5 wt % to about 3.5 wt %. In additional aspects, the pumpkin seed protein may have a concentration in the protein composition of about 0.5 wt % to about 1 wt %, about 1 wt % to about 1.5 wt %, about 1.5 wt % to about 2 wt %, about 2 wt % to about 2.5 wt %, about 2.5 wt % to about 3 wt %, or about 3 wt % to about 3.5 wt %. In yet additional aspects, the pumpkin seed protein may have a concentration in the protein composition of about 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, or about 3.5 wt %. In one example, the pumpkin seed protein has a concentration in the protein composition of about 1 wt %.

C. Protein Blend

In some embodiments, the protein blend composition may be used alone or with other ingredients to create the consumer products. The protein blend may include the first plant protein ingredient and the second plant protein ingredient described herein in Sections IA and IB, respectively. In some aspects, the protein blend may be mixed with other ingredients that can include a gum blend, a lecithin, sweeteners, flavors, a creamer, salt, and combinations thereof as described in the following sections. In some additional aspects, the protein blend composition can be the foundation ingredients to create the desired consumer products.

The PDCAAS score of the protein blend may be determined by methods known to those having skill in the art. In some embodiments, the PDCAAS score of the protein blend may be at least about 0.9. In some aspects, the PDCAAS score of the protein blend may be about 0.9 to about 0.91, about 0.91 to about 0.92, about 0.92 to about 0.93, about 0.93 to about 0.94, about 0.94 to about 0.95, about 0.95 to about 0.96, about 0.96 to about 0.97, about 0.97 to about 0.98, about 0.98 to about 0.99, about 0.99 to about 0.999, or about 0.999 to about 1. In some aspects, the PDCAAS score of the protein blend may be about 0.9, 0.91, 0.92, 0.93, 0.94, 0.95, 0.96, 0.97, 0.98, 0.99, 0.999, or about 1. In one example, the PDCAAS score of the protein blend is 1.

The protein blend may be in the form of a granule or powder. In some embodiments, the protein blend may have a D₉₀ of about 200 μm to about 80 μm. In some embodiments the protein blend is from 150 μm to about 80 μm. In some embodiments the protein blend is from 110 μm to about 80 μm. In some embodiments, the protein blend may have a D₉₀ of less than about 200 μm, 190 μm, 180 μm, 170 μm, 160 μm, 150 μm, 140 μm, 130 μm, 120 μm 110 μm. In some embodiments the protein blend may have a D₉₀ from about 150 μm to about 105 μm, about 105 μm to about 100 μm, about 100 μm to about 95 μm, about 95 μm to about 90 μm, about 90 μm to about 85 μm, or about 85 μm to about 80 μm. In some additional aspects, the protein blend may have a D₉₀ of about 105 μm to about 85 μm or about 100 μm to about 90 μm. In yet additional aspects, the protein blend may have a D₉₀ of about 110 μm, 109 μm, 108 μm, 107 μm, 106 μm, 105 μm, 104 μm, 103 μm, 102 μm, 101 μm, 100 μm, 99 μm, 98 μm, 97 μm, 96 μm, 95 μm, 94 μm, 93 μm, 92 μm, 91 μm, 90 μm, 89 μm, 88 μm, 87 μm, 86 μm, 85 μm, 84 μm, 83 μm, 82 μm, 81 μm, or about 80 μm. In one example, the protein composition has a D₉₀ of about 90 μm.

D. Gum Blend

The protein composition of the present disclosure includes a gum blend. The gum blend imparts some of the unique rheological properties that give rise to improved mouthfeel and texture. In some embodiments, the gum blend may include gum Arabic, xanthan gum, guar gum, or other gums known to those having skill in the art, and combinations thereof. In one example, the gum blend includes a combination of gum Arabic, xanthan gum, and guar gum.

In some embodiments, the gum blend may have a concentration in the protein composition of about 0.25 wt % to about 4 wt %. In some aspects, the gum blend may have a concentration of about 0.25 wt % to about 0.5 wt % about 0.5 wt % to about 1 wt %, about 1 wt % to about 1.5 wt %, about 1.5 wt % to about 2 wt %, about 2 wt % to about 2.5 wt %, about 2.5 wt % to about 3 wt %, about 3 wt % to about 3.5 wt %, or about 3.5 wt % to about 4 wt %. In additional aspects, the gum blend may have a concentration in the protein composition of about 0.25 wt %, 0.5 wt %, 0.75 wt %, 1 wt %, 1.25 wt %, 1.5 wt %, 1.75 wt %, 2 wt %, 2.25 wt %, 2.5 wt %, 2.75 wt %, 3 wt %, 3.25 wt %, 3.5 wt %, 3.75 wt %, or about 4 wt %. In one example, the gum blend is a combination of gum Arabic, xanthan gum, and guar gum, and has a concentration in the protein composition of about 2 wt %.

E. Lecithin

The protein composition of the present disclosure includes a lecithin. The lecithin imparts some of the rheological properties that give rise to improved mouthfeel and texture. In some embodiments, the lecithin may include plant lecithin or animal lecithins. In some aspects, the plant lecithins may include sunflower lecithin, soy lecithin, rapeseed lecithin, cottonseed lecithin, or other plant lecithins known in the art, and combinations thereof. In some additional aspects, the animal lecithins may include egg lecithin, milk lecithin, fish lecithin, or other lecithins known in the art, and combinations thereof. In one example, the lecithin is a sunflower lecithin.

In some embodiments, the lecithin may have a concentration in the protein composition of about 0.5 wt % to about 3.5 wt %. In some aspects, the lecithin may have a concentration of about 0.5 wt % to about 1 wt % about 1 wt % to about 1.5 wt %, about 1.5 wt % to about 2 wt %, about 2 wt % to about 2.5 wt %, about 2.5 wt % to about 3 wt %, or about 3 wt % to about 3.5 wt %. In some additional aspects, the lecithin may have a concentration in the protein composition of about 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.1 wt %, 2.2 wt %, 2.3 wt %, 2.4 wt %, 2.5 wt %, 2.6 wt %, 2.7 wt %, 2.8 wt %, 2.9 wt %, 3 wt %, 3.1 wt %, 3.2 wt %, 3.3 wt %, 3.4 wt %, or about 3.5 wt %. In one example, the concentration of the lecithin is about 1.3 wt %.

F. Additional Ingredient

The protein composition of the present disclosure may include additional ingredients commonly used in the art. In some embodiments, the protein composition may include sweeteners, flavors, a creamer, salts, vitamins and minerals, colorants, or combinations thereof.

i. Sweetener

In some embodiments, the protein composition may include sweeteners. In some aspects, the sweeteners may be natural or artificial sweeteners. Some examples of sweeteners include stevia, monk fruit, sugar, sugar alcohols (e.g., erythritol), saccharin, acesulfame, aspartame, neotame, sucralose, allulose, and other sweeteners known in the art and combinations thereof. In one example, the sweetener includes stevia and monk fruit.

It will be appreciated that the concentration of the sweetener may vary based on the other ingredients used in the protein composition disclosed herein. In some embodiments, the sweetener may have a concentration in the protein composition of about 0.10 wt % to about 1 wt %. In some aspects, the sweetener may have a concentration in the protein composition of about 0.10 wt % to about 0.25 wt %, about 0.25 wt % to about 0.5 wt %, about 0.5 wt % to about 0.75 wt %, or about 0.75 wt % to about 1 wt %. In further aspects, the sweetener may have a concentration of about 0.10 wt % to about 1 wt %, about 0.20 wt % to about 0.90 wt %, about 0.2 wt % to about 0.80 wt %, about 0.3 wt % to about 0.8 wt %, about 0.4 wt % to about 0.7 wt %, or about 0.5 wt % to about 0.6 wt %. In yet additional aspects, the sweetener may have a concentration in the protein composition of about 0.10 wt %, 0.15 wt %, 0.20 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, 0.9 wt %, 0.95 wt %, or about 1 wt %. In one example, the sweetener has a concentration in the protein composition of about 0.5 wt %.

ii. Flavor

In some embodiments, the protein composition may include flavors. In some aspects, the flavors may be natural or artificial flavors. Some examples of flavors include, vanilla flavor, chocolate flavor, cocoa powder, masking flavors, and other flavors known in the art and combinations thereof.

It will be appreciated that the concentration of the flavors may vary based on the other ingredients used in the protein composition disclosed herein and based on the desired flavor effect. In some embodiments, the concentration of the flavor may be from about 1 wt % to about 12 wt % in the protein composition. In some aspects, the concentration of the flavors may be about 1 wt % to about 2 wt %, about 2 wt % to about 3 wt %, about 3 wt % to about 4 wt %, to about 5 wt %, about 5 wt % to about 6 wt %, about 6 wt % to about 7 wt %, about 7 wt % to about 8 wt %, about 8 wt % to about 9 wt %, about 9 wt % to about 10 wt %, about 10 wt % to about 11 wt %, about 11 wt % to about 12 wt %. In some additional aspects, the concentration of the flavor in the protein composition may be about 2 wt % to about 11 wt %, about 3 wt % to about 10 wt %, about 4 wt % to about 8 wt %, or about 5 wt % to about 6 wt %. In yet additional aspects, the concentration of the flavor in the protein may be about 1 wt %, about 2 wt %, 3 wt %, 4 wt %, 5 wt %, 6 wt %, 7 wt %, 8 wt %, 9 wt %, 10 wt %, 11 wt %, or about 12 wt %. In one example, the concentration of the flavor in the protein composition is about 6 wt %. In another example, the concentration of the flavor in the protein composition is about 12 wt %.

iii. Creamer

In some embodiments, the protein composition may include a creamer, such as a creamer blend. In some embodiments, the creamer may be plant-based or dairy-based.

In some aspects, the creamer may have a concentration of about 7 wt % in the protein composition. In some embodiments, the concentration of the creamer may be from 0 wt % to about 12 wt % in the protein composition. In some aspects, the concentration of the flavors may be about 1 wt % to about 2 wt % to about 3 wt %, about 3 wt % to about 4 wt %, to about 5 wt %, to about 6 wt %, to about 7 wt %.

iv. Salts

In some embodiments, the protein composition may include salt. In some aspects, the salt may include sea salt, table salt, iodized salt, kosher salt, sodium chloride, potassium chloride, salt substitutes, and other salts known to those having ordinary skill in the art and combinations thereof. In one example, the salt is sea salt.

It will be appreciated that the concentration of salt in the protein composition may be varied to achieve different flavors. In some embodiments the salt may have a concentration in the protein composition of about 0.5 wt % to about 1 wt %. In some aspects, the salt may have a concentration in the protein composition of about 0.5 wt % to about 0.6 wt %, about 0.6 wt % to about 0.7 wt %, about 0.7 wt % to about 0.8 wt %, about 0.8 wt % to about 0.9 wt %, or about 0.9 wt % to about 1 wt %. In some additional embodiments, the salt may have a concentration in the protein composition of about 0.6 wt % to about 0.9 wt % or about 0.7 wt % to about 0.8 wt %. In yet additional embodiments, the salt may have a concentration in the protein composition of about 0.5 wt %, 0.6 wt %, 0.7 wt %, 0.8 wt %, 0.9 wt %, or about 1 wt %. In one example, the concentration of the salt is about 0.8 wt %.

v. Vitamins and Minerals

In some embodiments, the protein composition may include vitamins and minerals. Methods of making and procuring vitamins and minerals are known to those having skill in the art. The vitamins and minerals that may be included in the protein composition may include vitamin A, vitamin B1, vitamin B2, vitamin B3, vitamin B5, vitamin B6, vitamin B9, vitamin B12, vitamin C, vitamin D, vitamin E, vitamin K, biotin, choline, calcium, chloride, chromium, copper, fluoride, iodine, iron, magnesium, manganese, molybdenum, phosphorus, potassium, selenium, sodium, sulfur, zinc, retinoids, carotene, thiamin, riboflavin, niacin, pantothenic acid, pyridoxine, cobalamin, ascorbic acid, calciferol, alpha-tocopherol, folic acid, phylloquinone, menadione, and other vitamins and minerals known to those having skill in the art.

vi. Colorants

In some embodiments, the protein composition may include colorants. Methods of making and procuring colorants are known to those having skill in the art. The colorants that may be used in the protein composition may include Brilliant Blue FCF, Indigotine, Fast Green FCF, Erythrosine, Allura Red AC, Tartrazine, Sunset Yellow FCF, annatto, caramel, carmine, elderberry juice, lycopene, paprika, curcumin, cartenoids, chlorophyllin, anthocyanins, betanin, and other colorants known to those having skill in the art.

vii. Preservatives

In some embodiments, the protein composition may include preservatives. Methods of making and procuring preservatives are known to those having skill in the art. The preservatives that may be used in the protein composition may include sorbates, benzoates, benzoic acid, parabens, sulfur dioxide, sulfites, nitrites, nitrates, lactic acid, propionates, ascorbic acid, sodium ascorbate, butylated hydroxytoluene, butylated hydroxyanisole, gallic acid, sodium gallate, tocopherols, citric acid, and other preservatives known to those having skill in the art.

G. Protein Beverage Composition

The protein composition of the present disclosure may be used in a beverage, such as a RTD (ready-to-drink) or an RTM (ready-to-mix) composition. The beverage may include a protein blend and/or protein composition having any of the ingredients described in Sections IA to IF above. In one example, the protein composition includes a protein blend comprising a first plant protein ingredient and a second plant protein ingredient, a gum blend, and additional ingredients selected from the group consisting of flavors, sweeteners, a creamer, and salt. In a second example, the protein composition includes a protein blend comprising a first plant protein ingredient and a second plant protein ingredient, a gum blend, a lecithin, and additional ingredients selected from the group consisting of flavors, sweeteners, a creamer, and salt.

The protein composition may be mixed in a liquid to create the beverage. In some embodiments, the liquid may be tap water, distilled water, cow's milk, goat milk, plant-based milk (e.g., almond milk, soy milk, coconut milk, etc.), or juice (e.g., orange juice, apple juice, grape juice, cranberry juice, etc.). In some embodiments, the amount of liquid added is between about 4 oz. and about 12 oz. In some aspects, the amount of liquid added is between about 4 oz. and about 4.5 oz, about 5 oz. and about 5.5 oz, about 6 oz. and about 6.5 oz, 7 oz. and about 7.5 oz, about 8 oz. and about 8.5 oz, about 9 oz. and about 9 oz., about 10 oz. and about 10.5 oz., about 10.5 oz. and about 11 oz., about 11 oz. and about 11.5 oz., or about 11.5 oz. and about 12 oz. In some additional aspects, the amount of liquid added is about 4 oz., 4.5 oz., 5 oz., 5.5 oz., 6 oz., 6.5 oz., 7 oz., 7.5 oz., 8 oz., 8.5 oz., 9 oz., 9.5 oz., 10 oz., 10.5 oz., 11 oz., 11.5 oz., or about 12 oz. In some examples, the amount of liquid added is between about 10 oz. to about 12 oz.

In some embodiments, the amount of protein composition mixed with liquid to create the protein beverage composition may be between about 30 g and about 50 g. In some aspects, the amount of protein composition in the protein beverage composition may be about 35 g to about 45 g. In some additional aspects, the amount of protein composition in the protein beverage composition may be about 30 g to about 35 g, about 35 g to about 40 g, about 40 g to about 45 g, or about 45 g to about 50 g. In yet additional aspects, the amount of protein composition in the protein beverage composition may be about 30 g, 31 g, 32, g, 33 g, 34 g, 35 g, 36 g, 37 g, 38 g, 39 g, 40 g, 41 g, 42 g, 43 g, 44 g, 45 g, 46 g, 47 g, 48 g, 49 g, or about 50 g. In one example, the amount of protein composition in the protein beverage composition is about 38 g. In another example, the amount of protein composition in the protein beverage composition is about 41 g.

In some embodiments, the protein beverage composition may have a D₉₀ of about 200 μm to about 80 μm. In some embodiments the protein blend is from 150 μm to about 80 μm. In some embodiments the protein blend is from 110 μm to about 80 μm. In some embodiments, the protein blend may have a D₉₀ of less than about 200 μm, 190 μm, 180 μm, 170 μm, 160 μm, 150 μm, 140 μm, 130 μm, 120 μm 110 μm. In some embodiments the protein blend may have a D₉₀ from about 150 μm to about 105 μm, about 105 μm to about 100 μm, about 100 μm to about 95 μm, about 95 μm to about 90 μm, about 90 μm to about 85 μm, or about 85 μm to about 80 μm. In some additional aspects, the protein blend may have a D₉₀ of about 105 μm to about 85 μm or about 100 μm to about 90 μm. In yet additional aspects, the protein blend may have a D₉₀ of about 110 μm, 109 μm, 108 μm, 107 μm, 106 μm, 105 μm, 104 μm, 103 μm, 102 μm, 101 μm, 100 μm, 99 μm, 98 μm, 97 μm, 96 μm, 95 μm, 94 μm, 93 μm, 92 μm, 91 μm, 90 μm, 89 μm, 88 μm, 87 μm, 86 μm, 85 μm, 84 μm, 83 μm, 82 μm, 81 μm, or about 80 μm. In one example, the protein composition has a D₉₀ of about 90 μm.

The PDCAAS score of the protein beverage composition may be determined by methods known to those having skill in the art. In some embodiments, the PDCAAS score of the protein beverage composition may be at least about 0.9. In some aspects, the PDCAAS score of the protein beverage composition may be about 0.9 to about 0.91, about 0.91 to about 0.92, about 0.92 to about 0.93, about 0.93 to about 0.94, about 0.94 to about 0.95, about 0.95 to about 0.96, about 0.96 to about 0.97, about 0.97 to about 0.98, about 0.98 to about 0.99, about 0.99 to about 0.999, or about 0.999 to about 1. In some aspects, the PDCAAS score of the protein beverage composition may be about 0.9, 0.91, 0.92, 0.93, 0.94, 0.95, 0.96, 0.97, 0.98, 0.99, 0.999, or about 1. In one example, the PDCAAS score of the protein beverage composition is 1.

The protein beverage composition may have rheological properties that impart better mouthfeel and texture characteristics compared to other protein beverage compositions. In one embodiment, the protein beverage composition of the present disclosure is a shear-thinning fluid.

In some examples, the protein beverage composition may have a shear viscosity of about 1,000 mPa-s to about 30,000 mPa-s at a shear rate of about 0.5 s⁻¹ to about 100 s⁻¹ when diluted with 8 oz. of water. In some additional examples, the protein beverage composition may have a shear viscosity of about 550 mPa-s to about 50 mPa-s at a shear rate of about 0.5 s⁻¹ to about 100 s⁻¹ when diluted with 10 oz. of water. In still other examples, the protein beverage composition may have a shear viscosity of about 300 mPa-s to about 30 mPa-s at a shear rate of about 0.5 s⁻¹ to about 100 s⁻¹ when diluted with 12 oz. of water.

Additionally, the protein blend composition may be used in a variety of products applications including but not limited to 1) baked goods, such as cookies, cakes, pizza crust, tacos, bread, tortillas, bagels, waffles, 2) liquid products including semi-solid puddings, soups, baby foods and smoothies, 3) extruded products such as breakfast cereals, chips, crackers, croutons, pet goods, and 4) other unique products such as energy bars, ice creams and Jell-O® or gelatin products.

### II. Methods

Further disclosed herein are methods of making a protein composition that has a superior amino acid profile and that, when mixed with a liquid, imparts superior mouthfeel characteristics. The method includes adding a first half of a first plant protein ingredient to a vessel, adding a second protein ingredient to the vessel adding a second half of the first plant protein ingredient to the vessel, and mixing the contents of the vessel. The first plant protein ingredient and the second plant protein ingredient may be the first plant protein ingredient and second plant protein ingredient described in Sections IA and IB, respectively, above.

The method may further include adding a gum blend to the vessel after adding the second protein ingredient to the vessel but before adding the second half of the first plant protein ingredient to the vessel. The gum blend may be the gum blend described in Section ID above.

The method may further include adding a lecithin to the vessel after adding the second protein ingredient to the vessel but before adding the second half of the first plant protein ingredient to the vessel. The lecithin may be the lecithin described in Section IE above.

The method may further include adding additional ingredients selected from the group consisting of flavors, sweeteners, a creamer, salt, and combinations thereof, after adding the second protein ingredient to the vessel but before adding the second half of the first plant protein ingredient to the vessel. The additional ingredients may be those described in Section IF above.

The method may further include adding water as the final step to produce a protein beverage composition as described in Section IG above.

### EXAMPLES

### Example 1: Vanilla Protein Composition

A protein composition of the present disclosure was created. One serving of the composition included the following:
a. Plant Protein Blend (Pea Protein, Rice Protein, Chickpea Protein, Pumpkin Protein, Watermelon Seed Protein)
b. Creamer Blend
c. Sunflower Lecithin
d. Sweeteners
e. Gum Blend
f. Flavors
g. Salt

Half of the pea protein and half of the rice protein were added to a vessel. Next, the remaining ingredients were added before adding the second half of the pea protein and the rice protein. The ingredients were then mixed until uniform. 38 g of the above formulation was then mixed with about 10-12 fluid ounces of water to create a vanilla protein beverage composition.

### Example 2: Chocolate Protein Composition

A protein composition of the present disclosure was created. One serving of the composition included the following:
a. Plant Protein Blend (Pea Protein, Rice Protein, Chickpea Protein, Pumpkin Protein, Watermelon Seed Protein)
b. Creamer Blend
c. Sunflower Lecithin
d. Sweeteners
e. Gum Blend
f. Flavors
g. Salt

Half of the pea protein and half of the rice protein were added to a vessel. Next, the remaining ingredients were added before adding the second half of the pea protein and the rice protein. The ingredients were then mixed until uniform. 41 g of the above formulation was then mixed with about 10-12 fluid ounces of water to create a chocolate protein beverage composition.

### Example 3: Vanilla Protein Composition

A protein composition of the present disclosure was created. One serving of the composition included the following:
a. Plant Protein Blend (Pea Protein, Rice Protein, Chickpea Protein, Pumpkin Protein, Watermelon Seed Protein)
b. Creamer Blend
c. Sweeteners
d. Gum Blend
e. Flavors
f. Salt

Half of the pea protein and half of the rice protein were added to a vessel. Next, the remaining ingredients were added before adding the second half of the pea protein and the rice protein. The ingredients were then mixed until uniform. 38 g of the above formulation was then mixed with about 10-12 fluid ounces of water to create a vanilla protein beverage composition.

### Example 4: Chocolate Protein Composition

A protein composition of the present disclosure was created. One serving of the composition included the following:
a. Plant Protein Blend (Pea Protein, Rice Protein, Chickpea Protein, Pumpkin Protein, Watermelon Seed Protein)
b. Creamer Blend
c. Sweeteners
d. Gum Blend
e. Flavors
f. Salt

Half of the pea protein and half of the rice protein were added to a vessel. Next, the remaining ingredients were added before adding the second half of the pea protein and the rice protein. The ingredients were then mixed until uniform. 41 g of the above formulation was then mixed with about 10-12 fluid ounces of water to create a chocolate protein beverage composition.

### Example 3: Particle Size Distribution

The particle size distribution of a composition of the present disclosure was compared to the particle size of two similar protein products. One serving of each protein composition was used: 38 g of the protein composition of the present disclosure (Prototype 1), 38 g of the protein composition of the present disclosure (Prototype 2—without lecithin), 46 g of Competitor 1, and 34 g of Competitor 2. The serving size of each Competitor protein composition was determined by the recommended serving size. Each of the protein compositions was diluted with water to 12 ounces. The results are shown in the following table:

| | D₁₀ (μm) | D₅₀ (μm) | D₉₀ (μm) | Mean (μm) |
|---|---|---|---|---|
| Prototype 1 | 10.8 | 40.3 | 85.2 | 45.7 |
| Prototype 2 | 12.2 | 51.8 | 132.7 | 43.9 |
| Competitor 1 | 36.6 | 127.4 | 298.4 | 152.4 |
| Competitor 2 | 19.3 | 70.0 | 485.6 | 176.7 |

Each of the particle sizes is shown in microns. D₁₀ refers to the maximum diameter of the smallest 10% of particles. D₅₀ refers to the maximum diameter of the smallest 50% of particles. D₉₀ refers to the maximum diameter of the smallest 90% of particles. As can be seen from the data in the table, the disclosed compositions have significantly smaller particle size in each of the three categories compared to the Competitor 1 and Competitor 2 compositions. This small particle sizes were predicted to contribute better mouthfeel and reduced grittiness in the disclosed protein composition.

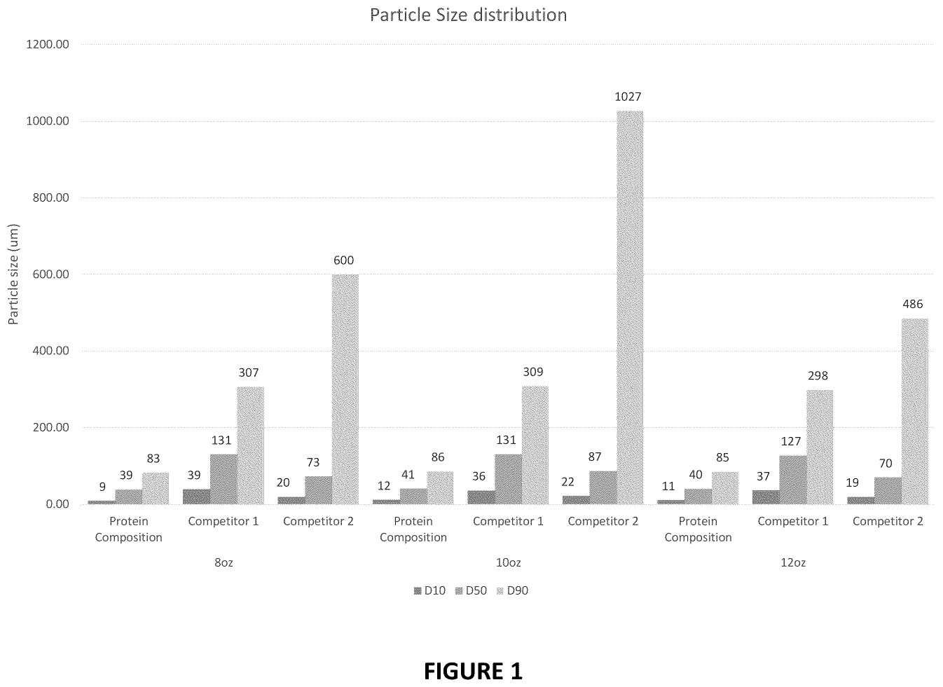

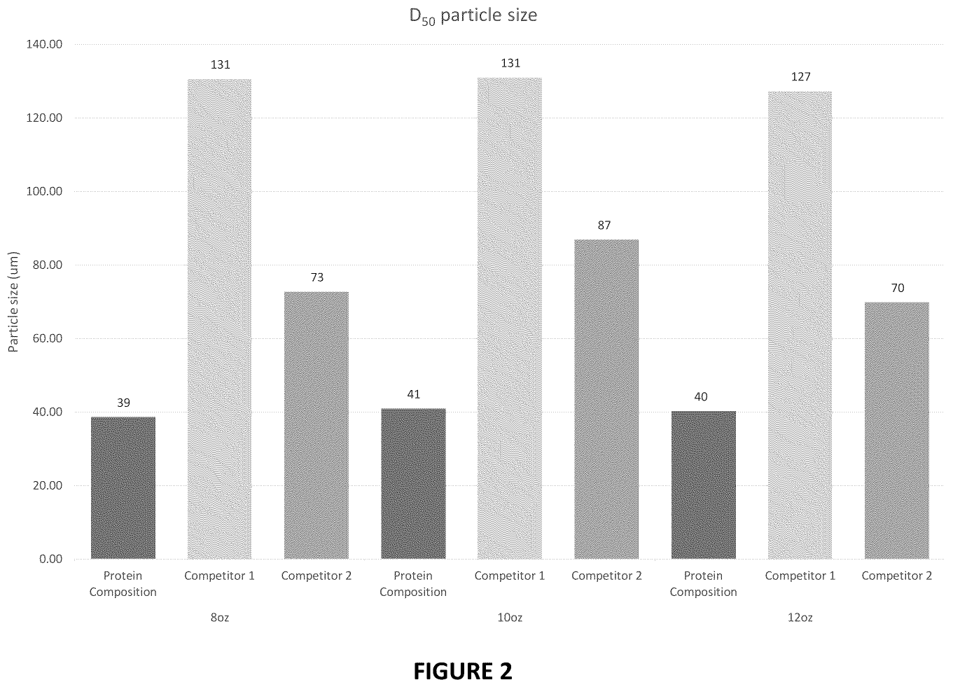

Further studies were conducted to determine particle size at different levels of dilution. Particle size distribution tests were conducted at dilution levels of 8 ounces, 10 ounces, and 12 ounces. Again, the D₁₀, D₅₀, and D₉₀ values were determined. The results are reported in FIG. 1. The results for just D₅₀ particle size distribution values are reported in FIG. 2. Again, it is clear that the disclosed composition has significantly smaller particle size than the Competitor 1 and Competitor 2 products.

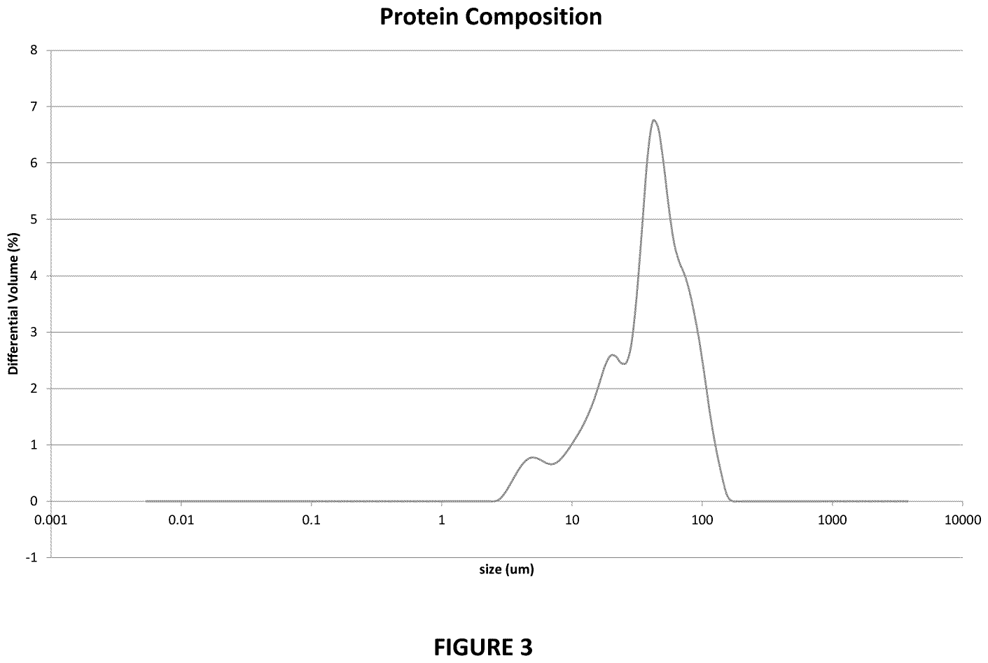

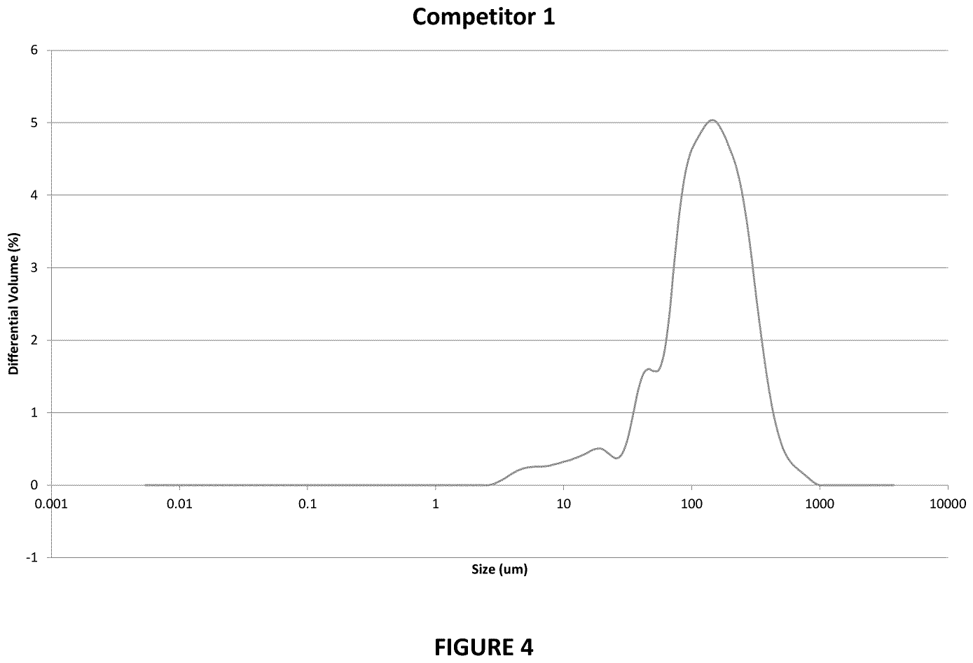

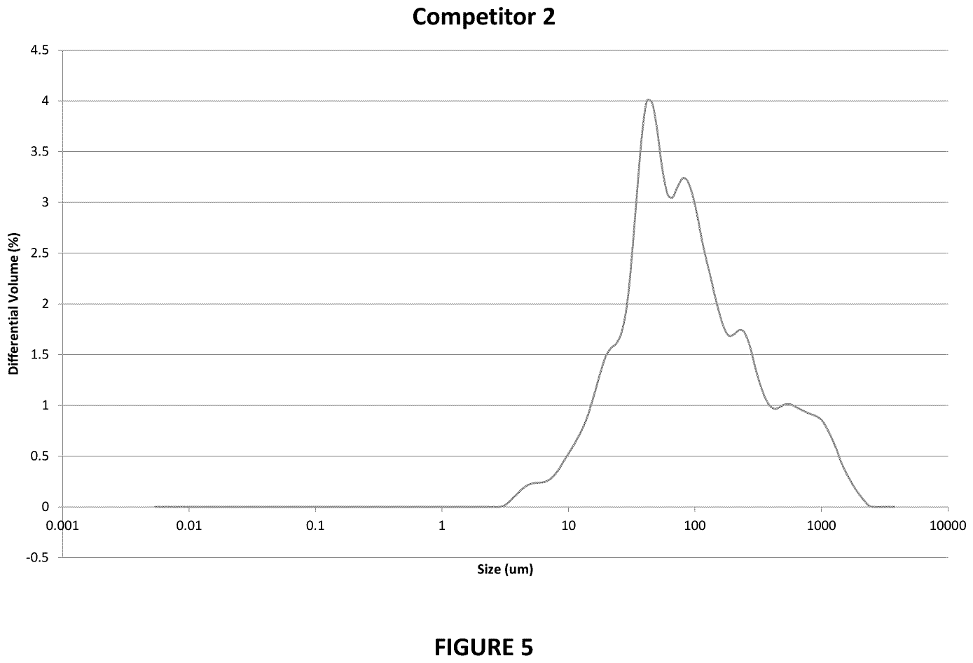

Further studies were conducted to determine the overall particle size distribution curve for the disclosed composition. The particle size distribution curve for the disclosed composition is shown in FIG. 3. As can be seen, the peak particle size appears well below 100 μm. The particle size distribution curve for the Competitor 1 composition is shown in FIG. 4. The particle size distribution curve for the Competitor 1 composition peaks between 100 and 200 μm. The particle size distribution curve for the Competitor 2 composition is shown in FIG. 5. The particle size distribution curve for the Competitor 2 composition shows a peak in particle size distribution below 100 μm but has a large trailing end that extends to about 2000 μm. These results clearly show that the particle size distribution of the claimed composition is smaller than similar protein compositions.

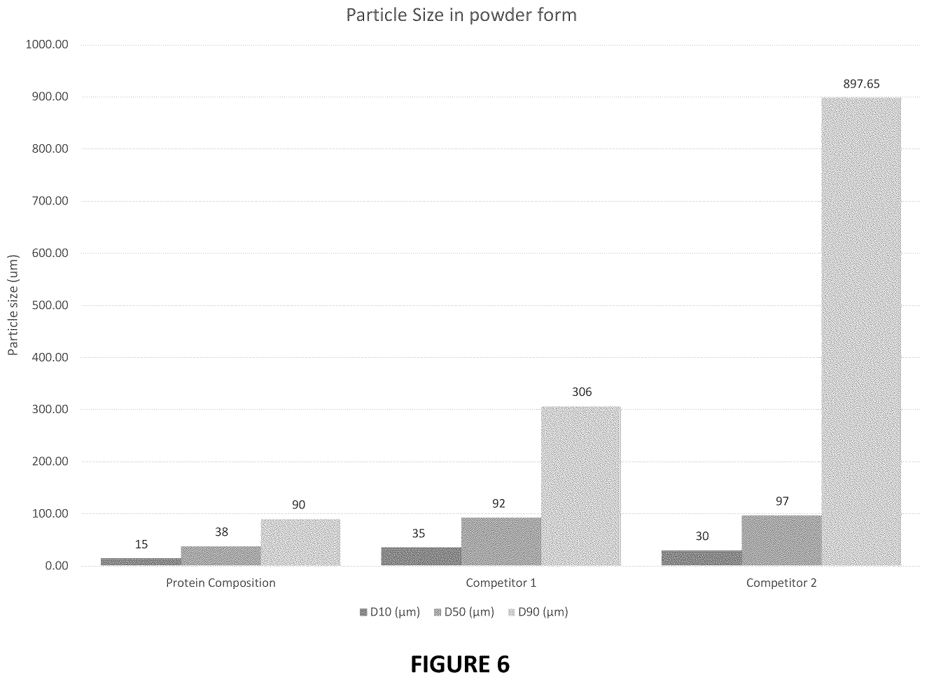

The particle size of the protein compositions in powder form is shown in FIG. 6. The particle size distribution again shows that the disclosed composition has far smaller particle size than the Competitor 1 or Competitor 2 compositions at the D₁₀, D₅₀, and D₉₀ intervals.

It should also be noted that the particle size distribution curves for the disclosed product have a more normal distribution compared to the Competitor 1 and Competitor 2 products. A smoother and more normal PSD may indicate smoother mouthfeel perception, as less pronounced peaks may contribute to less varied or less apparent texture discrepancies.

### Example 4: Rheology

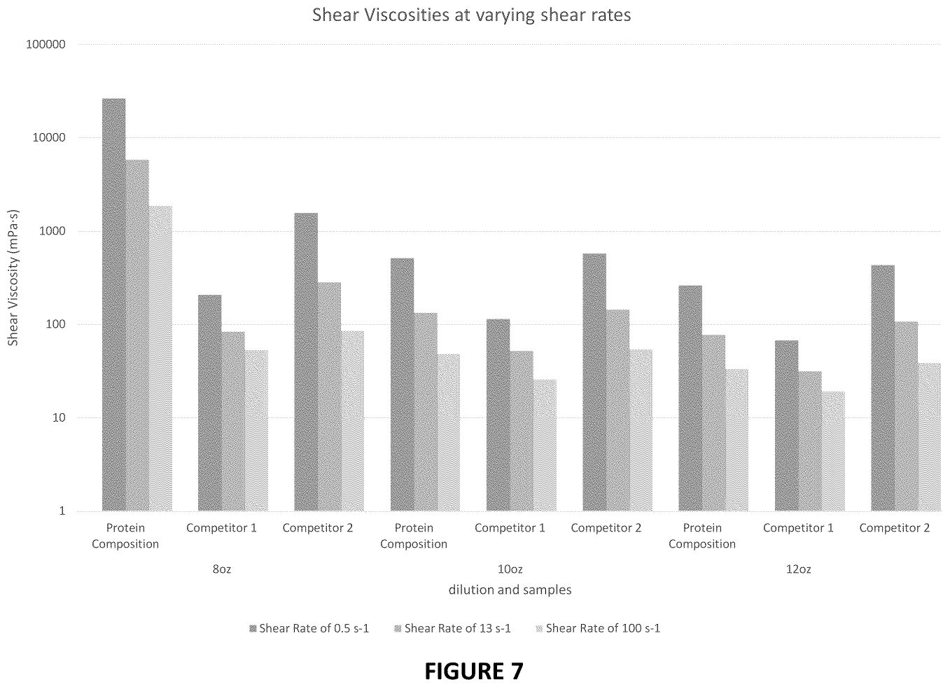

The rheological qualities of the disclosed protein composition were measured. The shear viscosity (mPa-s) of the disclosed protein composition, a Competitor 1 composition, and a Competitor 2 composition were measured at shear rates of 0.5 s⁻¹, 13 s⁻¹, and 100 s⁻¹. These qualities were measured at dilutions of 8 oz, 10 oz, and 12 oz. The results are shown in FIG. 7.

As can be seen from FIG. 7, the shear viscosity of each protein composition dropped as the shear rate increased, indicating that the disclosed protein composition is a shear-thinning fluid. Of particular note, the shear viscosity of the disclosed composition dropped significantly when diluted as compared to the Competitor 1 and Competitor 2 products. This shows that when the disclosed protein composition is more concentrated, it demonstrates more elastic behavior. This is crucial, as elasticity relates to mouthfeel, dispersibility, and wettability for protein compositions and is therefore a desirable trait.

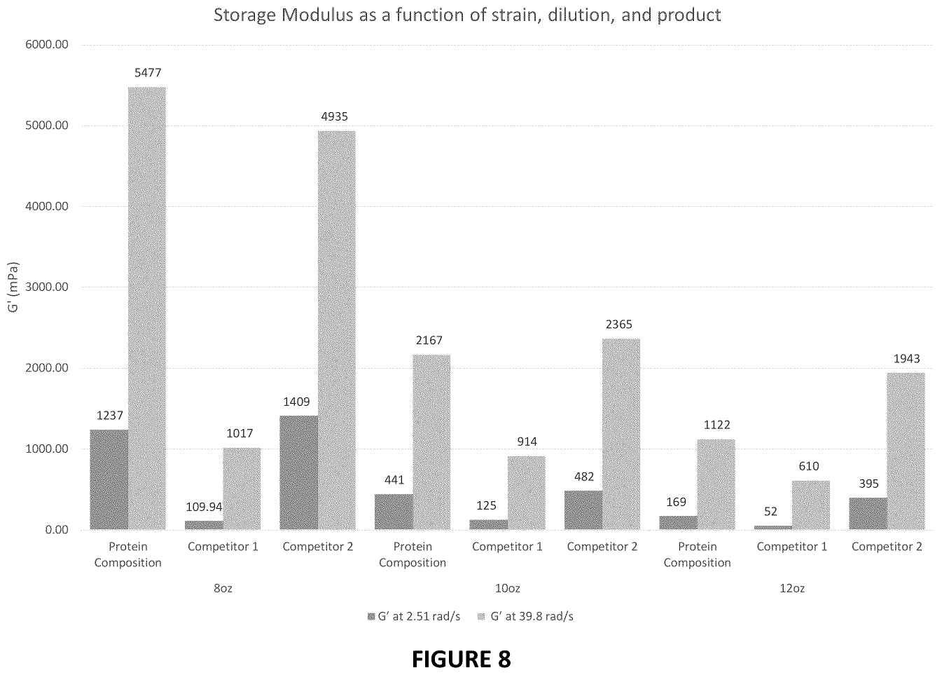

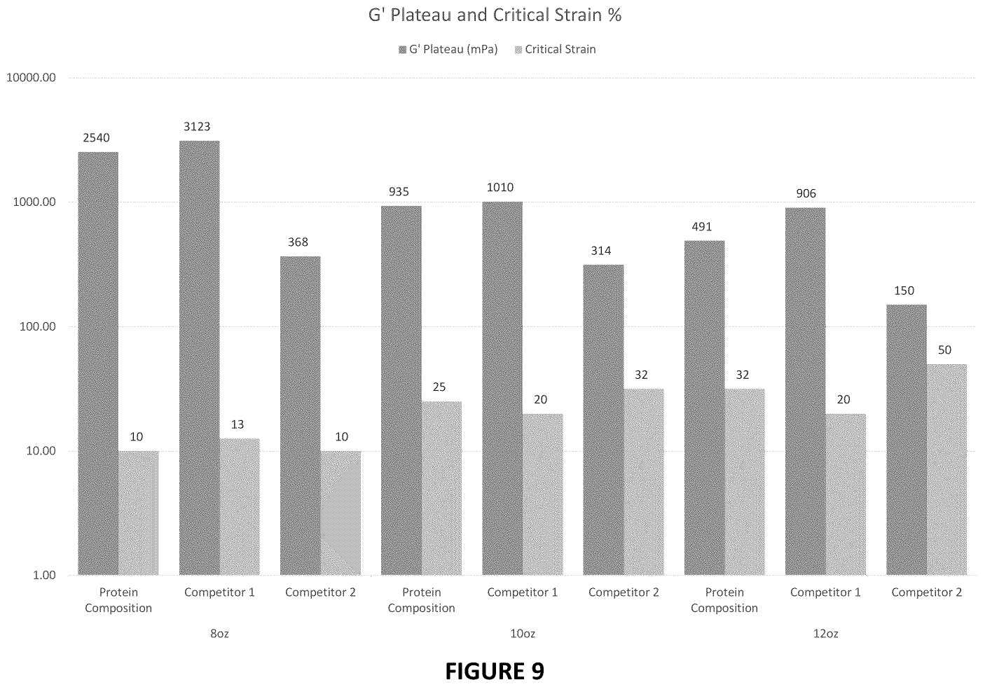

Furthermore, the storage modulus (G′; measured in mPa) of the disclosed composition was measured and compared with the Competitor 1 product and the Competitor 2 product at dilutions of 8 oz, 10 oz, and 12 oz. The storage modulus was measured at strains of 2.51 rad/s and 39.8 rad/s. The results are shown in FIG. 8. The storage modulus plateau and critical strain percentage were also measured. These results are shown in FIG. 9.

As can be seen from FIGS. 8 and 9, the storage modulus of the disclosed protein composition at high strain rates is larger than that of the Competitor 1 and Competitor 2 compositions 8 oz. of dilution, but drops dramatically at a dilution of 12 oz. to lower than the Competitor 2 composition. This unique behavior further indicates high elasticity and better mouthfeel.

### Example 4: Consumer Mouthfeel Testing

Consumer tests were conducted to determine whether the mouthfeel and other sensory aspects of the disclosed protein composition performed better than competitor products. The tests for the vanilla products included 214 consumers and lasted 75 minutes. The tests for the chocolate products included 216 consumers and lasted 60 minutes. All products used in the tests were mixed with refrigerated distilled water in blender bottles (blender balls removed). Criteria for consumer participation included having worked out 4 or more times in the last 30 days, having purchased and consumed protein powder in the past year, consuming protein powder mixed with cold water, and an openness to plant-based protein powder. The products tested included a vanilla prototype composition of the present disclosure (Vanilla Prototype), a chocolate prototype composition of the present disclosure (Chocolate Prototype), Competitor 1 chocolate and vanilla products, and Competitor 2 chocolate and vanilla products.

### Vanilla Plant-Based Protein Powder Results

Consumers were asked to evaluate 3 products (Vanilla Prototype 1, Competitor 1, and Competitor 2 for taste, followed by a 15-minute break. Then, the consumers were asked to evaluate four products (Vanilla Prototype 1, Vanilla Prototype 2, Competitor 1 Essentials Vanilla, and Competitor 2 Organic Protein Vanilla Bean).

When asked to rate their liking for the mouthfeel and consistency of the vanilla protein powder compositions, consumers rated the vanilla prototype compositions significantly higher than the Competitor 1 or Competitor 2 compositions. The mean ratings given by consumers are reported in the following Table. Means with unique uppercase letters were significantly different at a 95% confidence interval.

| | Vanilla Prototype 1 | Competitor 1 | Competitor 2 |
|---|---|---|---|
| Overall Consistency/ | 6.2 A | 4.8 B | 4.5 B |
| Mouthfeel Liking | | | |
| Creamy Mouthfeel | 6.4 A | 4.9 B | 4.5 B |
| Liking | | | |
| Thickness Liking | 6.2 A | 5.0 C | 4.4 D |
| Smooth Mouthfeel | 6.3 A | 5.1 B | 4.7 B |
| Liking | | | |
| Mouthcoating Liking | 6.1 A | 4.9 B | 4.6 B |

This data shows that the protein composition described herein provides better mouthfeel than competitor products.

Additionally, consumers were asked to rate several other qualities of the protein composition using a “Just About Right” (JAR) scale. The target score was to have at least 65% of respondents rate the quality as Just About Right. The results are reported in the following Table, with bolded scores indicating those that met the target.

| | Vanilla Prototype 1 | Competitor 1 | Competitor 2 |
|---|---|---|---|
| Creaminess | | | |
| Too Creamy | 15% | 8% | 10% |
| JAR | 71% | 57% | 47% |
| Not Creamy Enough | 13% | 36% | 43% |
| Thickness | | | |
| Too Thick | 32% | 12% | 12% |
| JAR | 58% | 54% | 42% |
| Not Thick Enough | 10% | 34% | 47% |
| Smoothness | | | |
| Too Smooth | 5% | 5% | 9% |
| JAR | 75% | 68% | 58% |
| Not Smooth Enough | 20% | 27% | 33% |
| Grittiness | | | |
| Too Gritty | 39% | 42% | 39% |
| JAR | 53% | 50% | 48% |
| Not Gritty Enough | 8% | 8% | 13% |
| Mouthcoating | | | |
| Too Much | 21% | 22% | 25% |
| JAR | 74% | 65% | 60% |
| Not Enough | 6% | 13% | 15% |

As can be seen in the Table, the prototype vanilla products outperformed the competitors in every single category, earning a higher percentage of JAR scores. Furthermore, the prototype vanilla products reached the target JAR score for creaminess, smoothness, and mouthcoating. Taken together, the results show that the vanilla prototype products had empirically better mouthfeel than other products.

### Chocolate Plant-Based Powder Results

Consumers were asked to evaluate 3 products (Chocolate Prototype, Competitor 1, and Competitor 2) for taste, followed by a 5-minute break. Then, consumers were asked to evaluate the same three products for other qualities.

When asked to rate their liking for the mouthfeel and consistency of the vanilla protein powder compositions, consumers rated the chocolate prototype compositions significantly higher than the Competitor 1 or Competitor 2 compositions. The mean ratings given by consumers are reported in the following Table. Means with unique uppercase letters were significantly different at a 95% confidence interval.

| | Chocolate | | |
|---|---|---|---|
| | Prototype 1 | Competitor 1 | Competitor 2 |
| Overall Consistency/ | 6.2 A | 5.2 B | 5.0 B |
| Mouthfeel Liking | | | |
| Creamy Mouthfeel | 6.3 A | 5.3 B | 4.8 C |
| Liking | | | |
| Thickness Liking | 6.2 A | 5.4 B | 4.9 C |
| Smooth Mouthfeel | 6.2 A | 5.3 B | 5.3 B |
| Liking | | | |
| Mouthcoating Liking | 6.2 A | 5.1 B | 5.0 B |

This data shows that the protein composition described herein provides better mouthfeel than competitor products.

Additionally, consumers were asked to rate several other qualities of the protein composition using a “Just About Right” (JAR) scale. The target score was to have at least 65% of respondents rate the quality as Just About Right. The results are reported in the following Table, with bolded scores indicating those that met the target.

| | Chocolate | | |
|---|---|---|---|
| | Prototype 1 | Competitor 1 | Competitor 2 |
| Creaminess | | | |
| Too Creamy | 19% | 8% | 9% |
| JAR | 69% | 57% | 44% |
| Not Creamy Enough | 12% | 34% | 47% |
| Thickness | | | |
| Too Thick | 31% | 10% | 10% |
| JAR | 64% | 58% | 44% |
| Not Thick Enough | 5% | 32% | 46% |
| Smoothness | | | |
| Too Smooth | 6% | 4% | 8% |
| JAR | 69% | 59% | 59% |
| Not Smooth Enough | 25% | 38% | 33% |
| Grittiness | | | |
| Too Gritty | 38% | 51% | 38% |
| JAR | 54% | 37% | 51% |
| Not Gritty Enough | 8% | 13% | 11% |
| Mouthcoating | | | |
| Too Much | 25% | 24% | 25% |
| JAR | 72% | 57% | 54% |
| Not Enough | 3% | 19% | 2 1% |

As can be seen in above Table, the prototype chocolate product outperformed the competitors in every single category, earning a higher percentage of JAR scores. Furthermore, the prototype chocolate product reached the target JAR score for creaminess, smoothness, and mouthcoating, whereas neither competitor product reached this target. Taken together, the results show that the chocolate prototype products had empirically better mouthfeel than other products.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

1. A protein composition comprising:
a protein blend comprising:
a first plant protein ingredient, and
a second plant protein ingredient;
a gum blend; and
a lecithin.

2. The protein composition of claim 1, wherein the protein composition has a PDCAAS of at least 0.9.

3. The protein composition of claim 1, wherein the first plant protein ingredient comprises at least one protein selected from the group consisting of pea protein, rice protein, soy protein, and combinations thereof.

4. The protein composition of claim 1, wherein the first plant protein ingredient has a concentration of 50 wt % to 80 wt % in the protein composition.

5. The protein composition of claim 1, wherein the first plant protein ingredient is a combination of pea protein and rice protein, wherein the pea protein has a concentration of 50 wt % to 70 wt % in the protein composition and the rice protein has a concentration of 10 wt % to 30 wt % in the protein composition.

6. The protein composition of claim 1 wherein the second plant protein ingredient comprises at least one protein selected from chickpea protein, watermelon seed protein, pumpkin seed protein, chia seed protein, pea protein, rice protein, soy protein and combinations thereof.

7. The protein composition of claim 6, wherein the second plant protein ingredient has a concentration of about 0.5 wt % to about 7.5 wt % of the protein composition.

8. The protein composition of claim 1, wherein the lecithin is selected from the group consisting of sunflower lecithin, soy lecithin, and combinations thereof and further the concentration is from about 0.5 wt % to about 3.5 wt % in the protein composition.

9. The protein composition of claim 1 wherein the gum blend comprises gum Arabic, xanthan gum, and guar gum and wherein the gum blend has a concentration of about 0.25 wt % to about 4 wt % in the protein composition.

10. The protein composition of claim 1 wherein the protein composition further comprises ingredients selected from the group consisting of a creamer, flavor ingredients, sweeteners, salts, and combinations thereof.

11. The protein composition of claim 1 wherein about 90% of the particles of the protein composition have a diameter of less than about 200 μm.

12. A protein beverage composition comprising:
a protein composition comprising:
a protein blend comprising a first plant protein ingredient and a second plant protein ingredient;
a gum blend;
a lecithin; and
a liquid.

13. The protein beverage composition of claim 12 further comprising additional ingredients selected from the group of flavors, sweeteners, a creamer, salt, and combinations thereof.

14. The protein beverage composition of claim 12, wherein the protein beverage composition has a PDCAAS of at least about 0.9.

15. The protein beverage composition of claim 12, wherein the particles of the protein beverage composition have a diameter of less than about 200 μm.

16. The protein beverage composition of claim 12, wherein the liquid comprises water, animal-based milk, plant-based milk, or juice.

17. A protein composition comprising:
a protein composition comprising:
a protein blend comprising a first plant protein ingredient and a second plant protein ingredient; and,
a gum blend.

18. The protein composition of claim 17 further comprising additional ingredients selected from the group consisting of lecithin, flavors, sweeteners, a creamer, salt, and combinations thereof.

19. The protein composition of claim 17, wherein the protein composition has a PDCAAS of at least about 0.9 and wherein the particles of the protein composition have a diameter of less than about 200 μm.

20. The protein composition of claim 17, wherein the protein composition is a powder.
